(19) United States
(12) Patent Application Publication
(10) Pub. No.: US 2020/0393410 A1
(43) Pub. Date: Dec. 17, 2020

(54) TECHNIQUES FOR MASS ANALYSIS OF AEROSOL PARTICLES

(71) Applicant: Waters Technologies Corporation, Milford, MA (US)

(72) Inventor: Joseph A. Jarrell, Newton Highlands, MA (US)

(21) Appl. No.: 16/903,969

(22) Filed: Jun. 17, 2020

Related U.S. Application Data
(60) Provisional application No. 62/862,300, filed on Jun. 17, 2019.

(51) Int. Cl. G01N 27/62; H01J 49/00

(52) U.S. Cl. CPC G01N 27/622; H01J 49/40; H01J 49/009

(57) ABSTRACT

Techniques and apparatus for forming and analyzing ions of particulate samples. In one embodiment, for example, an ion source device may include an inlet to receive a sample comprising a plurality of particles arranged within a carrier gas, a fluid source to provide a fluid, a droplet formation region to generate droplets from the plurality of particles using the fluid, and at least one ion formation device to form ions via ionizing at least a portion of the droplets. Other embodiments are described

### CROSS REFERENCE TO RELATED APPLICATIONS

This application claims priority to U.S. Provisional Application No. 62/862,300, filed Jun. 17, 2019 and entitled “TECHNIQUES FOR MASS ANALYSIS OF AEROSOL PARTICLES”, which is hereby incorporated by reference.

### TECHNICAL FIELD

Embodiments herein generally relate to mass spectrometry and, more particularly, to an ion source for a mass analysis device operative to generate ions from particle droplets.

### BACKGROUND

The ability to analyze particles, such as aerosol particles, is important to a wide range of analytical fields, such as atmospheric chemistry, semiconductor manufacturing, explosives investigations, pollution analysis, and/or the like. Condensation-nucleation light scattering (CNLS) is a common technique for analyzing aerosol particles. In CNLS, aerosol particles may be exposed to a vapor. The aerosol particles may act as nucleation sites for vapor condensation, forming droplets. The droplets may pass through a beam of light, allowing a CNLS analyzer to detect the passage of the droplets by measuring an amount of scattered light as the droplets pass through the beam. However, CNLS may only be effective for a certain range of particle sizes, which may not include particles of interest, and does not provide for detailed, accurate measurements available via more sophisticated mass analysis methods (such as mass spectrometer (MS) devices). Another technique may include electron impact (EI) ionization of aerosol particles. Although EI ionization may allow for mass analysis of particles, conventional forms of this technique may produce copious fragmentation of analyte molecules, which is not effective for various experiments, including, for example, organic aerosols that may contain thousands of different compounds.

### SUMMARY

In accordance with various aspects of the described embodiments is an ion source device that may include an inlet to receive a sample comprising a plurality of particles arranged within a carrier gas a fluid source to provide a fluid, a droplet formation region to generate droplets from the plurality of particles using the fluid, and at least one ion formation device to form ions via ionizing at least a portion of the droplets.

In some embodiments of the ion source, the sample may include aerosol particles. In various embodiments of the ion source, the fluid may include at least one of N-butanol, isopropyl alcohol, ethanol, or water. In exemplary embodiments of the ion source, the fluid may be provided via one of a wick or a porous structure. In various embodiments of the ion source, the droplet formation region may include a heated saturation region and a cooled condensation region. In some embodiments of the ion source, the fluid may be arranged within the heated saturation region. In some embodiments of the ion source, the carrier gas may be come combined with the fluid within the heated saturation region to form a saturated gas. In various embodiments of the ion source, the saturated gas may flow from the heated saturation region to the cooled condensation region.

In exemplary embodiments of the ion source, the fluid of the saturated gas may condense around at least a portion of the plurality of particles within the cooled condensation region via condensation nucleation, where the plurality of particles may operate as nucleation sites for the fluid. In various embodiments of the ion source, the at least one ion formation device may include an impactor pin. In some embodiments of the ion source, the impactor pin may have a charge of about +/−0.1 kV to about +/−5 kV. In some embodiments of the ion source, the droplets may contact the impactor pin substantially one at a time. In various embodiments of the ion source, the ion formation device may include at least one of an impactor pin, an electric field, a corona discharge device, and an electrospray device. In exemplary embodiments of the ion source, the ion source may be coupled to a mass analyzer to analyze the ions.

In accordance with various aspects of the described embodiments is a method that may include receiving a sample at an ion source device, the sample comprising a plurality of particles arranged within a carrier gas, providing a fluid within a fluid source, generating droplets within a droplet formation region from the plurality of particles using the fluid, and forming ions via at least one ion formation device by ionizing at least a portion of the droplets.

In some embodiments of the method, the sample may include aerosol particles. In various embodiments of the method, the fluid may include at least one of N-butanol, isopropyl alcohol, ethanol, or water. In exemplary embodiments of the method, the fluid may be provided via one of a wick or a porous structure. In various embodiments of the method, the droplet formation region may include a heated saturation region and a cooled condensation region. In some embodiments of the method, the fluid may be arranged within the heated saturation region. In various embodiments of the method, the carrier gas may become combined with the fluid within the heated saturation region to form a saturated gas. In exemplary embodiments of the method, the saturated gas may flow from the heated saturation region to the cooled condensation region.

In various embodiments of the method, the fluid of the saturated gas may condense around at least a portion of the plurality of particles within the cooled condensation region via condensation nucleation, where the plurality of particles may operate as nucleation sites for the fluid. In some embodiments of the method, the at least one ion formation device may include an impactor pin. In exemplary embodiments of the method, the impactor pin may have a charge of about +/−0.1 kV to about +/−5 kV. In various embodiments of the method, the droplets may contact the impactor pin substantially one at a time.

### BRIEF DESCRIPTION OF THE DRAWINGS

FIG. 1 illustrates an embodiment of a first operating environment.

FIG. 2 illustrates an embodiment of a second operating environment.

FIG. 3 illustrates an embodiment of a third operating environment.

FIG. 4 illustrates an embodiment of a fourth operating environment.

FIG. 5 illustrates an embodiment of a fifth operating environment.

### DETAILED DESCRIPTION

Various embodiments may generally be directed toward systems, methods, and/or apparatus for performing mass analysis of a particulate sample. In some embodiments, the particulate sample may be or may include an aerosol sample. In various embodiments, a particulate analysis process may include mass spectral analysis of individual particles. The particulate analysis process may include accessing a particulate sample, forming droplets using the particles of the particulate sample as a nucleation site for a condensing vapor, and using the droplets as a vehicle for producing ions of the molecules forming the particles. In exemplary embodiments, the ions may be analyzed by a mass analyzer, such as a mass spectrometer (MS).

In some embodiments, particulate analysis processes may be used for air-borne particles or aerosols such as exist in the environment. In other embodiments, particulate analysis processes may include generating particulate samples from non-particulate (or substantially non-particulate) samples. For example, a non-particulate sample may be nebulized or otherwise converted to a particulate sample.

Conventional techniques for analyzing particulate samples may include condensation-nucleation light scattering (CNLS). In this technique, an aerosol may be introduced into a region containing a super-saturated condensable vapor, such as, for example, N-butanol, isopropyl alcohol, ethanol, water, and/or the like. Under appropriate typical conditions, aerosol particles as small as 2.5 nm may act as a nucleation site, and the super-saturated vapor may condense into a droplet around the particle nucleation site. Recently it has been demonstrated that in particular conditions, particles as small as 1 nm my also act as nucleation sites. These droplets can grow to 10 um in diameter in times on the order of 1 second or less at which point they may easily be counted individually by light scattering (i.e., CNLS). By controlling the degree of super-saturation and/or the amount of time the particle spends in the super-saturated region, smaller or larger droplets may be produced.

Conventional processes include mass spectral analysis of aerosol particles using electron impact ionization (EI). Standard EI processes, however, produce copious fragmentation of analyte molecules. Therefore, EI may not useful for the analysis of many sample types, including, for example, organic aerosols, that may contain thousands of different compounds.

Some embodiments may provide a technological advantage over conventional systems involving the ability to more efficiently and effectively analyze individual aerosol particles. For example, some embodiments may operate to more effectively embed and dissolve sample particles in a liquid environment prior to ionization. In another example, techniques according to some embodiments may provide for better identification techniques for certain classes of particles, such as biomolecules.

In this description, numerous specific details, such as component and system configurations, may be set forth in order to provide a more thorough understanding of the described embodiments. It will be appreciated, however, by one skilled in the art, that the described embodiments may be practiced without such specific details. Additionally, some well-known structures, elements, and other features have not been shown in detail, to avoid unnecessarily obscuring the described embodiments.

In the following description, references to “one embodiment,” “an embodiment,” “example embodiment,” “various embodiments,” etc., indicate that the embodiment(s) of the technology so described may include particular features, structures, or characteristics, but more than one embodiment may and not every embodiment necessarily does include the particular features, structures, or characteristics. Further, some embodiments may have some, all, or none of the features described for other embodiments.

As used in this description and the claims and unless otherwise specified, the use of the ordinal adjectives “first,” “second,” “third,” etc. to describe an element merely indicate that a particular instance of an element or different instances of like elements are being referred to, and is not intended to imply that the elements so described must be in a particular sequence, either temporally, spatially, in ranking, or in any other manner.

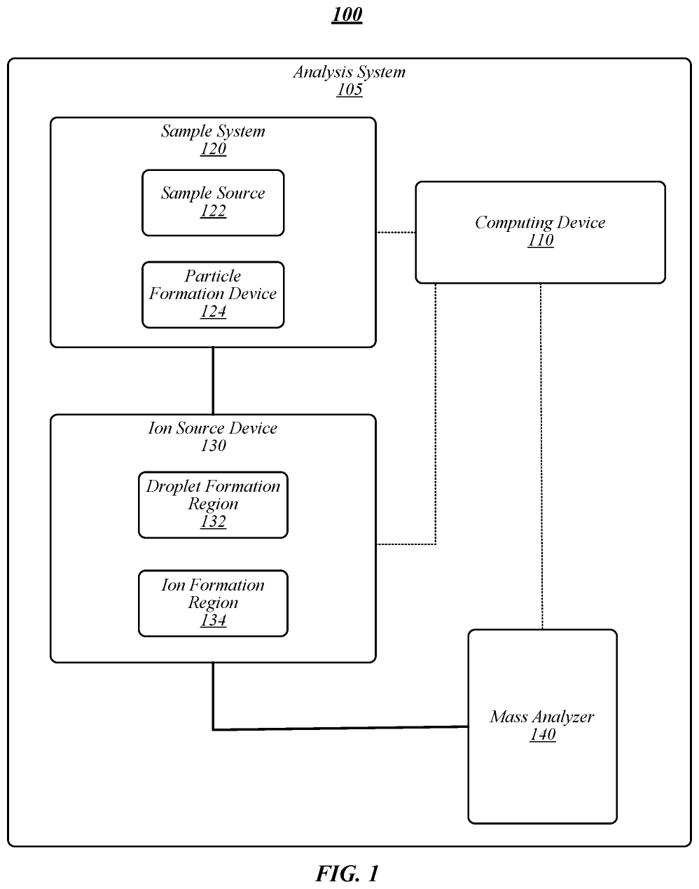

FIG. 1 illustrates an example of an operating environment 100 that may be representative of some embodiments. As shown in FIG. 1, operating environment 100 may include an analysis system 105 operative to perform mass analysis of a sample. In some embodiments, analysis system 105 may include a mass analyzer 140. In various embodiments, mass analyzer 140 may be or may include a mass spectrometry (MS) system, such as a time-of-flight MS (TOF-MS) system. For example, mass analyzer 140 may include a mass spectrometer, an ion mobility spectrometer, a TOF-MS, a quadrupole mass spectrometer, ion trap mass spectrometer, an Orbitrap mass spectrometer, a Charge Detection Mass Spectrometer, combinations thereof (for example, tandem MS-MS system, and/or the like), variations thereof, and/or the like. Although an MS system is used in examples in this detailed description, embodiments are not so limited, as other sample analysis systems capable of operating according to some embodiments are contemplated herein.

Analysis system 105 may include a sample system 120 operative to provide a sample to ion source device 130. In various embodiments, sample source 122 may provide a sample, such as an aerosol or other particulate sample. In other embodiments, sample source 122 may provide a liquid sample that may be formed into a particulate sample, such as an aerosol, by particulate formation device 124. In various embodiments, particulate formation device 124 may be or may include a nebulizer or other similar device. In exemplary embodiments, sample source 122 may be or may include a chromatography column, such as a liquid chromatography (LC) column. For example, eluent from an LC column of sample source 122 may be provided to particle formation device 124 to generate an aerosol sample for ion source device 130.

Ion source device 130 may operate to generate ions from a particulate sample provided via sample system 120. Ion source device 130 may include various components or regions, such as a droplet formation region 132 and/or an ion formation region 134. In some embodiments, at least one fluid (for instance, a droplet formation fluid) may be provided within droplet formation region 132. At least some of the particles of particulate sample entering the droplet formation region 132 may act as nucleation sites for droplet formation with the fluid. For example, the fluid may condense on the particles to form droplets. In various embodiments, droplet formation may be limited to particles of a certain size or size range. For example, variations in droplet formation conditions including, without limitation, temperature, pressure, type of fluid, amount of fluid, flow rate (for instance, the amount of time a particle remains in droplet formation region 132), fluid saturation levels (for instance, super-saturation levels), combinations thereof, and/or the like, may be used to limit droplet formation to droplets of a certain size or size range.

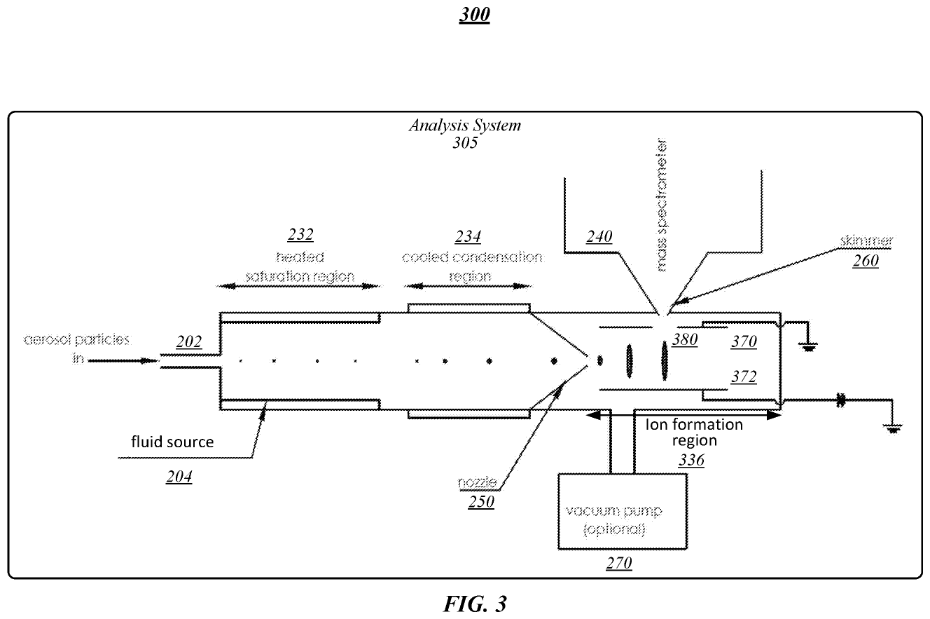

Droplet formation region 132 may be fluidically coupled to ion formation region 134. In some embodiments, the droplets may be used as a vehicle to form ions which may be analyzed via mass analyzer 140. For example, ion formation region 134 may form ions from at least a portion of the droplets entering ion formation region 134. In various embodiments, ion formation region 134 may include at least one ionizing element operative to form ions from the droplets. For example, an ionizing element may include an impactor pin operative to form ions from droplets contacting impactor pin. In some embodiments, an ionizing element may include a corona discharge needle. In exemplary embodiments, an ionizing element may include an electric field, for example, generated between two parallel electrodes (for instance, field-induced droplet ionization of FIG. 3). In various embodiments, ion formation region 134 may include a plurality of ionizing elements. Although an impactor pin, a corona discharge, and an electric field are used as illustrative ionizing elements, embodiments are not so limited, as other ionizing elements capable of operating according to some embodiments are contemplated herein. At least a portion of the ions formed via ion formation region 134 may be provided to mass analyzer 140 for mass analysis.

Analysis system 105 may include a computing device 110 operative to control, monitor, manage, or otherwise process various operational functions of analysis system 105. In some embodiments, computing device 110 may be or may include a stand-alone computing device, such as a personal computer (PC), server, tablet computing device. In other embodiments, computing device 110 may be or may include processing circuitry in combination with memory, software, and other operational components.

In some embodiments, computing device 110, sample system 120, ion source device 130, mass analyzer 140, and/or components thereof may include processing circuitry (not shown) to perform functions according to some embodiments. Processing circuitry may be any type of analog circuit or digital processor capable of executing programs, such as a microprocessor, digital signal processor, microcontroller, and/or the like. As used in this application, the terms “logic,” “circuitry,” and/or “module” are intended to refer to a computer-related or analog circuit-related entity, either hardware, a combination of hardware and software, software, or software in execution. For example, processing circuitry of computing device 110, sample system 120, ion source device 130, and/or mass analyzer 140 may operate to provide a sample to ion source device 130 at a particular flow rate, pressure, and/or other operational characteristics. In another example, processing circuitry of computing device 110 and/or mass analyzer 140 may operate to analyze signals received from a detector of mass analyzer 140 produced responsive to detection of ions at the detector to generate spectra or other analysis information, for instance, to identify constituents of a sample from sample source. In a further example, processing circuitry of computing device 110 and/or ion source device 130 may operate to control droplet formation conditions, for example, to limit or focus analysis via mass analyzer 140 to particles having certain characteristics, such as mass, weight, size, and/or the like.

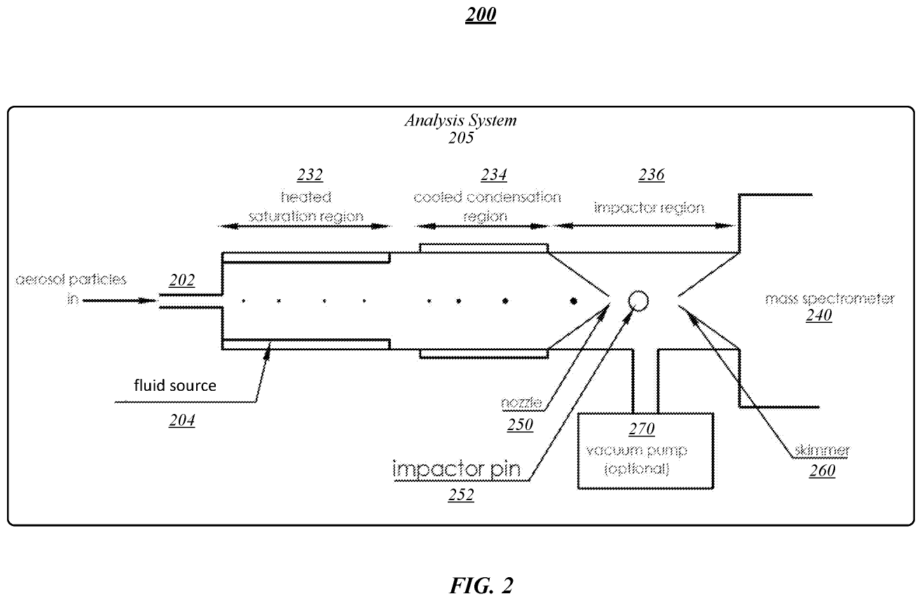

FIG. 2 illustrates an example of an operating environment 200 that may be representative of some embodiments. As shown in FIG. 2, operating environment 200 may include an analysis system 205 operative to mass analyze a particulate sample. Analysis system 205 may include a sample inlet 202 operative to receive the particulate sample, for example, aerosol particles. In some embodiments, the aerosol particles may be carried by a flowing or carrier gas into sample inlet and into a heated saturation region 232. In various embodiments, the flowing gas may include an inert, “clean,” or “pure” gas, such as argon, nitrogen, and/or the like. In some embodiments, ambient or “room” air may be used, for example, if substantially particle free. The flow rate used may vary depending on certain operating conditions, such as the physical scale of the instrument. For a typical bench top instrument, the flow rate may typically be in the range of about 0.1 to about 3 Litres per minute. Accordingly, a gaseous mixture or suspension of sample-flowing gas may enter heated saturation region via sample inlet 202. The particulate sample, such as the aerosol particles, may be an ambient particulate sample (or aerosol) and/or from a plume of particles originating from some other process or device, such as a nebulizer. In various embodiments, the particulate sample, such as aerosol particles, may be mixed with saturated gas prepared in a separate region.

A fluid may be arranged within one or more portions of analysis system, such as heated saturation region 232. The fluid may be provided in a fluid source 204, such as a wick, porous structure, nozzle, container, and/or the like. The fluid may include a condensable vapor. Heated saturation region 232 may provide an environment operative to facilitate the flowing gas to become saturated with fluid vapor. Illustrative environment properties of heated saturation region 232 may include temperature, pressure, volume, and/or the like. When n-butanol is used as the condensing fluid, a typical temperature for the saturation region will may be about 39° C., and the condensing region may be at about 10° C. for optimal performance. Other condensing fluids may perform optimally at one or more different temperatures. Typically, these devices work near atmospheric pressure and pressure differentials of fractions of an atmospheric may drive the gas flow through the system, but they can also be operated above and below atmospheric pressure. In some embodiments, for example, a saturating region might be a hollow cylindrical porous plastic wick about 1 inch in outer diameter, ⅜″ inner diameter and 6 inches long. In such embodiments, gas flow through the wick can be around 0.3 Litres per minute For example, a heated saturation region temperature and/or pressure may be specified to promote the flow of fluid from fluid source 204 into the space of heated saturation region 232 to saturate, mix, combine, or otherwise contact the sample-flowing gas combination. In this manner, the sample-flowing gas combination may become saturated or otherwise combined with the fluid.

In general, the fluid may include any type of fluid capable of forming droplets with particles of interest of the particulate sample. Non-limiting examples of the fluid may include N-butanol, isopropyl alcohol, ethanol, water, combinations thereof, and/or the like. In some embodiments, the fluid may include a single type of fluid. In other embodiments, the fluid may include a combination of a plurality of fluids. An operator may select the type of fluid based on various factors including, without limitation, properties of the particulate sample, desired droplet properties, particulates of interest (for instance, particulates of a certain size or size range), and/or the like.

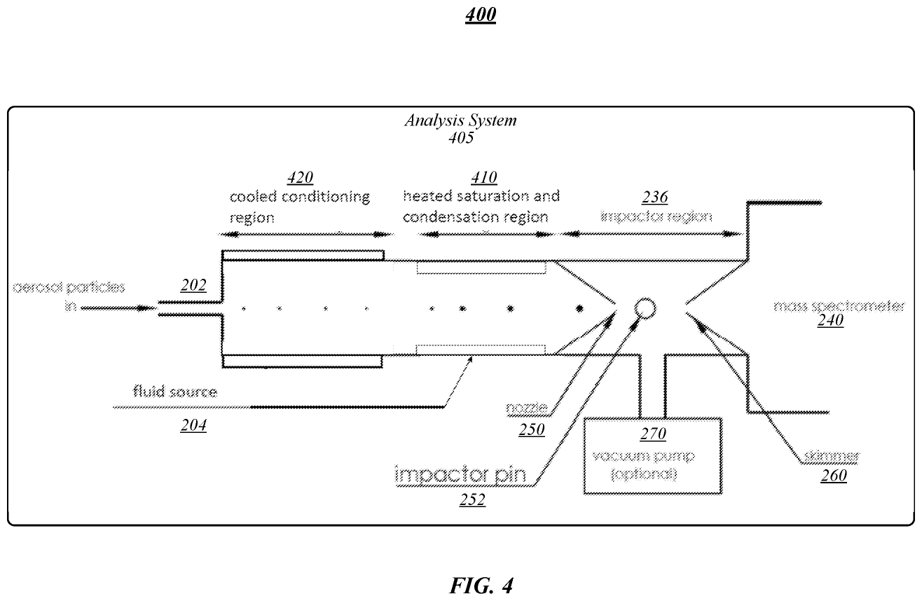

When water is used to produce a super-saturated condensable vapor, the same general principles described according to some embodiments may apply. Because water vapor has a much higher diffusion coefficient that most other condensable vapors used for CNLS, the geometry of the apparatus typically used may differ from that the embodiment described in FIG. 2 that is used for more common CNLS fluids. For example, FIG. 4 depicts operating environment 400 including an analysis system 405 configured as a water embodiment of analysis system 205. As shown in FIG. 4, analysis system 405 may include a heated saturation and condensation region 410 arranged downstream from a cooled conditioning region 420. For water, an ambient temperature flow of particles flows into and through a region containing a source of heated water vapor. Because water vapor diffuses faster than air or most gases conduct heat, and the flow in these devices is laminar, super-saturated water vapor is produced around the particles. Such devices are known and described, for example, in the following U.S. Pat. Nos. 6,712,881; 7,736,421; and 9,821,263.

A saturated gas formed in heated saturation region 232 (for instance, a gaseous suspension or mixture of sample, flowing gas, and fluid) may enter a cooled condensation region 234. Cooled condensation region 234 may provide an environment operative to facilitate the condensation of the fluid in the saturated gas. Illustrative environment properties of cooled condensation region 234 may include temperature, pressure, volume, and/or the like. In some embodiments, the particulate sample and/or portions thereof may be saturated (or pre-saturated) prior to entering cooled condensation region 234. For example, the particulate sample, such as aerosol particles, may be mixed with a pre-saturated flow of gas. In various embodiments, the pre-saturated sample may be introduced directly to cooled condensation region 234 (for instance, bypassing heated saturation region 232 or analysis system may not include heated saturation region 232).

In some embodiments, at least a portion of the particles of the particulate sample may act as nucleation sites for condensation of the fluid in the saturated gas within cooled condensation region 234. In various embodiments, the fluid and/or environmental properties of cooled condensation region 234 may be selected to facilitate formation of droplets using particle nucleation sites of a certain size or size range. For example, aerosol particles equal to or greater than a particular size may act as a nucleation site for the saturated vapor of the saturated gas, becoming contained within droplets of a certain droplet size (for instance, about 10 μm) within a droplet formation duration (for instance, about 1 second or less (s)). Non-limiting examples of particle sizes may include about 2.5 nm, about 3 nm, about 5 nm, about 10 nm, about 100 nm, about 1 μm, about 10 μm, about 25 μm, about 50 μm, about 100 μm, and/or any size or range of sizes between any two of these values (including endpoints). Droplet size may include, without limitation, about 10 nm, about 100 nm, about 1 μm, about 10 μm, about 25 μm, about 50 μm, about 100 μm, and/or any size or range of sizes between any two of these values (including endpoints). Embodiments are not limited in this context.

In various embodiments, heated saturation region 232 and cooled condensation region 234 may operate as a “droplet formation region” of analysis system 205. The droplets may enter an ion formation region 236 (or impactor region in the embodiment of FIG. 2) via a nozzle 250 or other opening. The droplets may operate as a vehicle for producing ions of the molecules of the particles, which may be detected by a mass analyzer, such as mass spectrometer 240. Ion formation region 236 may include one or more ion formation devices. In the example embodiment of FIG. 2, ion formation device may include an impactor pin 252. In some embodiments, droplets may impact an impactor pin 252 having a potential, such as about +/−5 Volts (V), about +/−20 V, about +/−50 V, about +/−100 V, about +/−200 V, about +/−0.5 kV, about +/−1 kV, about +/−2 kV, about +/−5 kV, about +/−10 kV, about +/−50 kV, about +/−100 kV, about +/−200 kV, about +/−500 kV, and/or any size or range of sizes between any two of these values (including endpoints). In general, the amount of the potential of impactor pin 252 may be selected as a sufficient amount to generate ions from droplets contacting impactor pin 252. In various embodiments, a positive potential may be applied to impactor pin 252 to generate positive ions. In other embodiments, a negative potential may be applied to impactor pin 252 to generate negative ions. In some embodiments, impactor pin 252 may be heated to a setpoint value. In some embodiments, the setpoint value may be about 50° C. to about 1000° C.

Each droplet contacting impactor pin 252 may produce an ion (for instance, a charged droplet or “droplet ion”). For example, droplet impact on impactor pin 252 (for instance, at a certain voltage and/or heated) may produce ionized molecules without fragmenting or otherwise breaking the molecules apart. In some embodiments, droplets may impact impactor pin 252 one at a time (or substantially one at a time). Accordingly, some embodiments may generate “soft ions” one at a time via impactor pin 252.

The droplet ions may flow through a skimmer 260 to mass spectrometer 240. In some embodiments, skimmer 260 may be concave with respect to impactor pin 252. In various other embodiments, skimmer 260 may be convex with respect to impactor pin. In some embodiments, skimmer 260 may have an orifice having an opening diameter of about 0.2 mm to about 4 mm.

In various embodiments, other ion formation elements 252 may be arranged within analysis system 205, alone or in addition to impactor pin 252. Accordingly, in some embodiments, analysis system 205 may include a single ion formation device 252. In other embodiments, analysis system 205 may include a plurality of ion formation devices 252. In some embodiments, a corona discharge device or needle may be arranged within ion formation region 236. In various embodiments, an electrospray device may be arranged within ion formation region 236. In exemplary embodiments, an electric field may be formed within ion formation region 236 (see, for example, FIG. 3).

In an exemplary embodiment, ion formation device 252 may be or may include a laser operative to form droplet ions. For example, a laser ion formation device 252 may include a transverse laser beam device. Properties of the laser may be selected to vaporize the droplets from cooled condensation region 234 and ionize molecules of interest. Non-limiting examples of properties of the laser may include power, wavelength, and/or the like.

Flow through analysis system 205 may be facilitated through various techniques. For example, a vacuum pump 270 may be operably coupled to a portion of analysis system 205. Operation of vacuum pump 270 may operate to cause the flow of the sample, flow gas, sample-gas mixture, droplets, and/or the like through heated saturation region 232, cooled condensation region 234, ion formation region 236, skimmer 260, and/or into mass spectrometer 240. In exemplary embodiments, a vacuum within mass spectrometer 240 may be used to draw gas, particles, and/or the like therein. In various embodiments, a pressure within ion formation region 236 may be lower compared to ambient pressure and/or other regions of analysis system 205 except, for example mass spectrometer 240. For example, the pressure in within ion formation region 236 may be lower (for instance, reduced via vacuum pump 270) relative to a region from which the particulate sample originates.

In various embodiments, analysis system 205 may be used as a discrimination or filter technique for analyzing certain types of molecules, biological elements (for instance, antibodies, viruses, and/or the like), and/or the like. For example, many large biomolecules of interest exist in a liquid environment that include compounds that may interfere with detection (for instance, a high salt liquid environment), which may limit the ability to ionize biomolecules of interest for providing to an analytical device, such as an MS device, for analysis. Using analysis system 205 according to some embodiments, a liquid sample may be diluted to a point where such interferences were reduced or even eliminated. The liquid sample may be diluted at various phases of analysis, such as pre-column, post-column, pre-injection, and/or the like. A diluted sample may be desolvated and sprayed, nebulized, or otherwise provided (non-charged) to analysis system 205 as a particulate sample. Because only larger biomolecules (for instance, about 7 kDa) may act as nucleation sites when the nucleation threshold size is 2.5 nm, certain biomolecules of interest may be ionized without interference from contaminants (or other compounds that are not of interest) of the mobile phase of conventional MS (for instance, LC-MS) systems. When desirable, in-line screens can be used to remove smaller particles from a flow of particles as described in U.S. Pat. No. 5,072,626. Non-limiting examples of biomolecules analysis that may benefit from analysis system 205 and techniques for operating analysis system 205 may include viruses and/or antibodies (for instance, in drug research and development), which may be typically about 1-100 MDa and about 150 kDa respectively

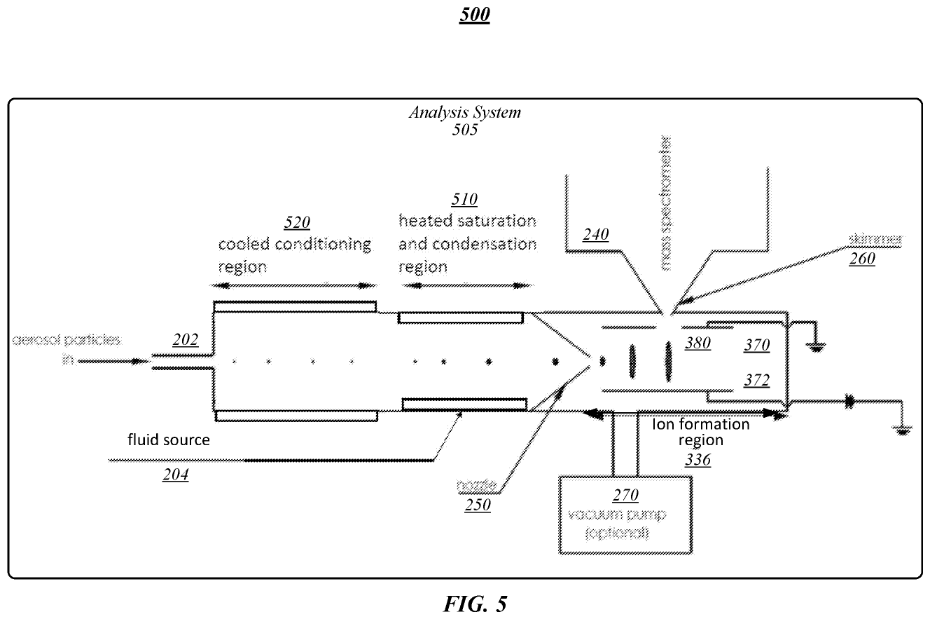

FIG. 3 illustrates an embodiment of a third operating environment. More specifically, FIG. 3 depicts an embodiment that includes field-induced droplet ionization. As shown in FIG. 3, droplets may enter ion formation region 336 of analysis system 305 via nozzle 250. In some embodiments, droplets may enter ion formation region 336 one at a time or essentially one at a time. In various embodiments, ion formation region 336 may include an electric field defined by electrodes 370, 372, for example, parallel plate electrodes. In some embodiments, upper electrode 370 may be held at ground, while lower electrode 372 may be held at a certain voltage (for instance, 1-20 kV). Droplets entering ion formation region 336 may elongate and symmetrically emit two oppositely charged jets toward electrodes 370, 372. In various embodiments, the jet may be directed toward electrode 370 and through an aperture to be sampled by mass spectrometer 240. FIG. 5 depicts operating environment 500 including an analysis system 505 configured as a water embodiment of analysis system 305. As shown in FIG. 5, analysis system 505 may include a heated saturation and condensation region 510 arranged downstream from a cooled conditioning region 520.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An ion source device, comprising:
an inlet to receive a sample comprising a plurality of particles arranged within a carrier gas;
a fluid source to provide a fluid;
a droplet formation region to generate droplets from the plurality of particles using the fluid; and
at least one ion formation device to form ions via ionizing at least a portion of the droplets.

2. (canceled)

3. The ion source device of claim 1, the fluid comprising at least one of N-butanol, isopropyl alcohol, ethanol, or water.

4. (canceled)

5. The ion source device of claim 1, the droplet formation region comprising a heated saturation region and a cooled condensation region.

6. The ion source device of claim 5, the fluid arranged within the heated saturation region.

7. The ion source device of claim 5, the carrier gas to become combined with the fluid within the heated saturation region to form a saturated gas.

8. The ion source device of claim 7, the saturated gas to flow from the heated saturation region to the cooled condensation region.

9. The ion source device of claim 8, the fluid of the saturated gas to condense around at least a portion of the plurality of particles within the cooled condensation region via condensation nucleation, where the plurality of particles operate as nucleation sites for the fluid.

10. (canceled)

11. (canceled)

12. The ion source device of claim 1, wherein the at least one ion formation device comprises an impactor pin and the droplets to contact the impactor pin substantially one at a time.

13. The ion source device of claim 1, the ion formation device comprising at least one of an impactor pin, an electric field, a corona discharge device, or an electrospray device.

14. The ion source device of claim 1, the ion source coupled to a mass analyzer to analyze the ions.

15. A method, comprising:
receiving a sample at an ion source device, the sample comprising a plurality of particles arranged within a carrier gas;
providing a fluid within a fluid source;
generating droplets within a droplet formation region from the plurality of particles using the fluid; and
forming ions via at least one ion formation device by ionizing at least a portion of the droplets.

16. (canceled)

17. The method of claim 15, the fluid comprising at least one of N-butanol, isopropyl alcohol, ethanol, or water.

18. (canceled)

19. The method of claim 15, the droplet formation region comprising a heated saturation region and a cooled condensation region.

20. The method of claim 19, wherein the fluid is arranged within the heated saturation region.

21. The method of claim 19, the carrier gas to become combined with the fluid within the heated saturation region to form a saturated gas.

22. The method of claim 21, the saturated gas to flow from the heated saturation region to the cooled condensation region.

23. The method of claim 22, the fluid of the saturated gas to condense around at least a portion of the plurality of particles within the cooled condensation region via condensation nucleation, where the plurality of particles operate as nucleation sites for the fluid.

24. (canceled)

25. (canceled)

26. The method of claim 15, wherein the ion formation device comprises an impactor pin and the droplets contact the impactor pin substantially one at a time.

27. The method of claim 15, the ion formation device comprising at least one of an impactor pin, an electric field, a corona discharge device, or an electrospray device.

28. The method of claim 15, comprising analyzing the ions via a mass analyzer.
